(19) United States
(12) Patent Application Publication
(10) Pub. No.: US 2026/0063410 A1
(43) Pub. Date: Mar. 5, 2026

(54) System and Method for Simultaneous Tube Measurement and Assembly

(71) Applicant: Joseph Gambino, Sandy, OR (US)

(72) Inventor: Joseph Gambino, Sandy, OR (US)

(21) Appl. No.: 18/816,875

(22) Filed: Aug. 27, 2024

(51) Int. Cl. G01B 5/08

(52) U.S. Cl. CPC G01B 5/08

(57) ABSTRACT

The present disclosure details a device meant to temporarily hold tube in place for measurement and fitting in an existing structure. The device contains an adhesive component to allow the device to quickly be attached, adjusted and removed to the existing structures. The device is fitted with a frictional component allowing friction to hold tube in the device securely. Multiple devices may be used at any one time to secure sections of tube for accurate placement and fitting. The device is designed to allow the fabricator to quickly and accurately monitor the distance from the centerline of tube from graduations present on the device.

### BACKGROUND OF THE INVENTION

When fitting tube to existing structures for fabrication, oftentimes tube is not straight; it contains bends which, when combined, form a very specific form. This 3-dimensional form creates planes in space with demanding and exacting 3-dimensional geometry. As these forms are created, it is essential for the worker to easily and effectively monitor the final form as it is assembled. Having multiple means of measuring tube sections as they construct the final form afford the fabricator the ability to assess and adjust the component structures to be in concert with the final design.

As one familiar in the art, it is known that a bent tube will have differing lengths on any given side where the measurement traverses any given line perpendicular to the cross section of the tube except where mirror planes occur due to the geometry of the particular bend. In the limit, these lengths occur as an infinite set which requires advanced calculation to monitor the accuracy and precision of the final design of the form.

As a means of simplifying the compounding complexity, the centerline of the tube remains constant regardless of the 2 and 3-dimensional geometry imposed by multiple bends to any given length of tube. To be able to monitor the centerline of any tube at any location along the length of tube regardless of the geometry affords the fabricator and the designer a great ability to monitor the specifics of how the complex 2 and 3-dimensional structure conforms to the intended design and function.

The device described herein affords a simple solution of measuring, monitoring and fitting tube with complex and varying 2 and 3 dimensional shapes to conforming existing structures by taking advantage of measuring and monitoring the centerline of any and all tube fitted together at any time or location along the section of tube and/or the entire structure.

The device depicted herein is cylindrical but not limited to said geometry; the device can be any shape that conforms to the cross-sectional geometry of tube being fitted. The definition of “tube” is any cross-sectional geometry of any geometric shape, i.e.: circular, triangular, square, rectangular, or any oblong permutations of said cross sectional geometry. Tube may be hollow or solid. For brevity, the device will be described with circular cross-sectional hollow tube geometry.

When designing and fabricating structures to existing structures, the ability to “dry fit” the assembly to the preexisting structure lends to an expedited and superior final structure. The device disclosed herein allows a quick and adjustable means of temporarily affixing an intended assembly to a preexisting structure. Frictional materials contained on the inner ring of the device allow for secure, temporary attachment to any tube to be dry fitted.

### BRIEF DESCRIPTION OF THE DRAWINGS

FIG. 1 illustrates the main components comprising the device wherein peripheral increments and frictional components in a 3-dimensional rendering of the device.

FIG. 2 illustrates a frontal view of the device with the increments along the periphery as well as the material intended to adhere the device to a pre-existing structure.

### SUMMARY OF THE INVENTION

The disclosed device is designed and used to temporarily hold tribe to existing structures allowing the fabricator to “dry fit” the designed structure to an existing structure. This ability of the device to fit tube to a structure affords expedited fabrication time due to how the device accommodates the tube to be fitted wherein the device provides measurements of the centerline of the fitted tube as well as spacing between the exterior wall of the tube to the structure the tube is to be fitted to.

### BACKGROUND

The device disclosed herein allows a fabricator to quickly and accurately fit a structure constructed of tube sections within an existing structure for final evaluation before making it permanent. The device is incremented on its periphery to monitor the dimensional fit to the pre-existing structure it intends to fit with. The device contains frictional components to hold the device securely to the tube which will be fit. Additionally, the device is fitted with magnets on its periphery coincident to the increments to make temporary the fit to the existing structure and allow changes to the fitted structure to optimize the fit to the pre-existing structure.

In other embodiments, the adhesive material may be non-magnetic wherein a solid, or semi-solid adhesive material may be used. Such materials may be of a gel-type consistency. The device's components may be made up of any combinations of materials herein, depending on the environment and constraints where tube is to be fitted. Such an example is when tube is needed on pre-existing semiconductor magnets, where the tube fitted and the device disclosed herein are non-ferromagnetic, such as tube of brass wherein the device disclosed herein is constructed out of aluminum with a semi-solid gel on the periphery to hold tube in place for fitting.

Another embodiment of the disclosed device is where the device is constructed from ceramic materials wherein the material applying friction may be constructed of a high temperature corrugated stainless steel, fitted with ferromagnets along the periphery. The specific construction materials of the device are dependent on environmental factors of the pre-existing structure however, the nature and function of the device remain constant.

### DETAILED DESCRIPTION OF THE INVENTION

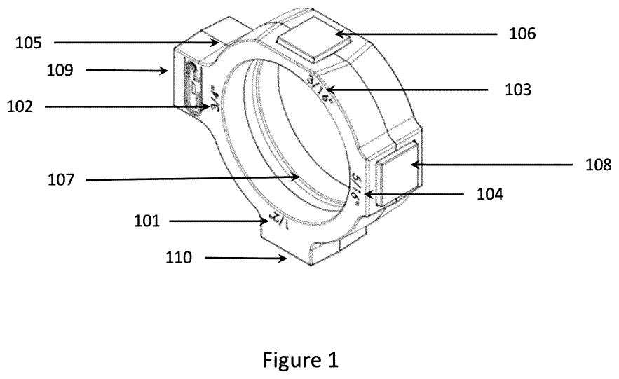

The device contains a material that allows adhesion to the pre-existing structure. A typical embodiment the exploits the properties of ferromagnetism present in existing structures to be fitted with non-linear tube sections. The outward facing wall of the device, as shown in FIG. 1, is fitted with a number of magnets (106, 108, 109, 110) to hold the device in any location onto the object being fitted with tube. The location of the magnets along the circumference of the device circumscribe the device allowing it to be placed in multiple locations with multiple contact points.

Additionally, FIG. 1 illustrates differing inscribed measurements (101,102, 103, 104) which allow the fabricator to adjust the distance of the centerline from the existing structure. This affords the fabricator quick and easy access to monitor the dry fit of the fabricated structure to the existing structure without any further measurement devices.

The device additionally exploits the frictional force wherein it applies friction onto the tube in question, keeping the tube secure to the device. In a typical embodiment, an elastomeric material is fitted within the interior circumference of the device (107) where contact is made with the tube section to be held. Once the device is fitted onto the tube, the tube will not translate or rotate. Multiple devices may be fit onto a singular tube section, or multiple tube sections facilitating multiple contact points within the structure the tube is being fit to.

The part of the device where the frictional component occurs, as well as where the magnets are fitted, typically may be a rigid material made out of aluminum, stainless steel, brass, various types of plastic, either molded or extruded or machined. The choice of material to house the frictional component

The interior wall of the device contains an appropriate geometry to accommodate a number of fittings wherein the fittings contact the tube preventing any movement. In one embodiment, the fitting on the interior of the device may be an elastomeric material such as an O-ring or an X-ring. Typically, the material on the interior of the device is more elastic than the material being held. Such materials may be brass rings, copper rings, corrugated or smooth, either in sections or continuous surrounding the pipe to be held.

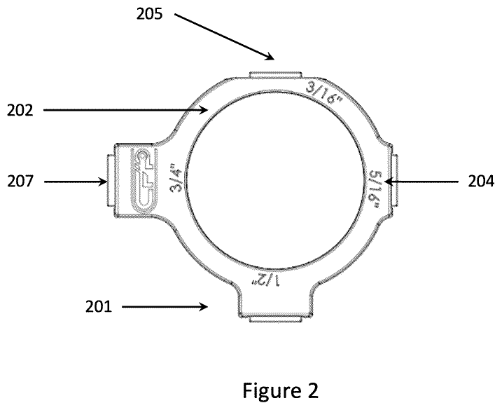

FIG. 2 illustrates the device from a frontal view. The incremental spacing along the periphery of the device may be seen at 201, 202, 203, 204. The device's adhesive components to allow the device to be temporarily attached to a pre-existing device may be seen at 205, 206, 207, 208.

1. A slide-on device used to quickly and temporarily attach poles/tubes/rods to metallic structures using a magnet or magnets for the purposes of establishing measurement centerlines or planes;

2. Where the device in #1 is made with 1 or more groove(s) for a(n) O-ring(s) or X ring, or other frictional type device of suitable material to create friction on a round tube, pipe, or rod so that the device in #1 stays in place and does not rotate once set in place by hand by the user;

3. Where the device in #1 has one or multiple frictional materials contained to facilitate friction;

4. Where the device in #1 has variable thickness so that the user can rotate the device to various positions to change its centerline distance from the structure;

5. Where the device is made using a clam-shell design that is centered around the magnet recesses wherein one or more recesses are present to accommodate a frictional component;

6. Where the device in #1 has the various radial thicknesses (or distance from centerline) marked on its surface to accurately set gaps between the round material and the structure.
